(19) United States
(12) Patent Application Publication
(10) Pub. No.: US 2003/0050380 A1
(43) Pub. Date: Mar. 13, 2003

(54) Calcined flint clay filler and solid surface made therewith

(76) Inventor: Lon Risley, Riverside, CA (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 09/949,334

(22) Filed: Sep. 7, 2001

(51) Int. Cl. C04B 14/10; C04B 33/04

(52) U.S. Cl. 524/445; 501/150; 106/486; 106/484; 501/143

(57) ABSTRACT

The present invention involves the use of fired clay, in particular flint clay, as a filler particulate and substitute for standard polymeric particulate commonly used in solid surface products. As well, it is also a substitute for ground stone as used in engineered stone products.

### TECHNICAL FIELD

The present invention relates to fillers used in surfacing materials such as clay fillers.

### BACKGROUND OF THE INVENTION

The modern surfacing market has historically concerned itself with producing durable products that may be used to cover floors, countertops, walls and bath areas, the earliest of these being stone.

Stone products, in a modern sense, provide an organic surfacing agent that is both durable and aesthetically pleasing. However, stone is inherently heavy and difficult to work with. Stone requires specialized tools, equipment and techniques so that it may be cut and fabricated into the desired shape, size and surface finish. Other less desirable aspects of stone is that there is considerable waste produced during its fabrication. Stone often times has hidden flaws, voids and cracks that are not apparent until once the stone has been cut. Additionally, many types of stone may include veins of calcium carbonate, kaolite, and other softer materials that will stain easily or have less wear resistance than the surrounding material.

Other related advances in surfacing materials have been the use of terrazzo, and terrazzo-like materials called “engineered stone.” Traditionally engineered stone was used exclusively for flooring. Stone chips were incorporated into a cement mixture and poured onto the flooring area to be covered, leveled and allowed to cure. Once cured, the covering was sanded repeatedly until the stone chip inclusions were uniformly exposed and the desired surface was polished. This process was time consuming and the product while durable, was extremely heavy.

Recently, terrazzo and other engineered stone products have moved away from the use of a cement matrix binder. Polymeric materials, epoxies, polyesters and urethanes are being used instead of a cement matrix binder. These materials still include stone pieces for a more natural appearance and durability. However, these engineered stone products retain many of the encumbrances inherent with the use of solid stone. They are heavy, often requiring additional structural support. Additionally, they are difficult to fabricate and require specialized cutting and polishing equipment. Further, in many cases, these products cannot be effectively repaired should they become damaged.

Modern solid surface materials have experienced great success and acceptance in today's market because they addressed many of the problems associated with stone and stone-like materials. These modern solid surface materials are comprised of pigmented polymeric chip fillers in a pigmented polymer matrix which are then cast into sheet form and allowed to cure. The advantages of this solid surface material is that it is relatively light in weight, durable, repairable, stain resistant, fire resistant and can be worked with common wood working tools. Aesthetically, most solid surface materials give the appearance of commonly available stone products and can be finished in either a matte or polished surface.

Yet, with all their advantages, solid surface products lack the natural organic appearance that can only be achieved with stone. Visually, and in comparison, natural stone, engineered stone and solid surface are easily distinguished. The technological advantages of solid surface materials have given these products a monotonous, manufactured, and sometimes, very synthetic appearance.

Therefore, there exists a need to develop a natural appearing solid surface product that retains and incorporates the technological advantages of modem solid surface materials, while at the same time, presenting the natural beauty and randomality of stone for use as a solid surface product.

### SUMMARY OF THE INVENTION

The present invention is a composition of matter prepared by a process comprising the steps of heating, in a rotary kiln, flint clay having a specific gravity of 2.381-2.418 to temperature of from approximately 900° F. to 1900° F. for approximately 90 minutes to 120 minutes, and thereafter recovering calcined flint clay having a specific gravity of 2.084-2.115 and a LOI of 1.5% to 4%.

Additionally, the present invention is a composition comprising a polyester resin solution and a calcined flint clay particle having an LOI of 1.5% to 4% in the 325 micron to one half inch size range.

The present invention is also a calcined flint clay particle having a specific gravity of 2.084-2.115 and a LOI of 1.5%-4%.

The present invention is a process of making a flint clay product useful as a filler comprising the steps of heating, in a rotary kiln, flint clay having a specific gravity of 2.381-2.418 to temperature of from approximately 900° F. to 1900° F. for approximately 90 minutes to 120 minutes, and thereafter recovering calcined flint clay having a specific gravity of 2.084-2.115 and a LOI of 1.5% to 4%.

Further, the present invention is a composition comprising a polyester resin solution, a calcined flint clay particle having an LOI of 1.5% to 4% in the 325 micron to one half inch size range, a colorant and a clear polyester particulate.

The present invention is a solid surface material comprising from 35-75 weight percent of a polyester resin, up to 0.25 weight percent of a colorant, up to 20.0 weight percent of a clear polyester particulate and from 25-65 weight percent of calcined flint clay in the 325 micron to one half inch range.

Additionally, the present invention comprises a method of making a solid surface product, comprising the steps of heating flint clay having a specific gravity of 2.381-2.418 to a temperature of from approximately 900° F. to 1900° F. for approximately 90 minutes to 120 minutes to form calcined flint clay having a specific gravity of 2.084-2.115 and a LOI of 1.5% to 4%, grinding the calcined flint clay, filling a vessel with approximately 30.0 to 55.0% of a polyester resin solution, adding to the polyester resin solution approximately 0.25 to 1.50% of at least one catalyst, and a pigment, further adding approximately 4.0 to 15.0% of a polyester particulate and approximately 30.0 to 60.0% of the ground calcined flint clay to form a mixture, mixing the mixture under high speed and vacuum to form a blended mixture, dispersing the blended mixture into molds, heating the blended mixture filled molds to form castings, and cooling the castings under controlled conditions.

The present invention comprises a method of making a solid surface product, comprising filling a vessel with approximately 30.0 to 55.0% of a polyester resin solution, adding to the polyester resin solution approximately 0.25 to 1.50% of at least one catalyst, and a pigment, further adding approximately 4.0 to 15.0% of a polyester particulate and approximately 30.0 to 60.0% of ground calcinated flint clay having an LOI of from 1.5% to 4% to form a mixture, mixing the mixture under high speed and vacuum to form a blended mixture, dispersing the blended mixture into molds, heating the blended mixture filled molds to form castings, and cooling the castings under controlled conditions.

The present invention comprises a composition of matter prepared by a process comprising the steps of heating flint clay having a specific gravity of 2.381-2.418 to a temperature of from approximately 900° F. to 1900° F. for approximately 90 minutes to 120 minutes to form calcined flint clay having a specific gravity of 2.084-2.115 and a LOI of 1.5% to 4%, grinding the calcined flint clay, filling a vessel with approximately 30.0 to 55.0% of a polyester resin solution, adding to the polyester resin solution approximately 0.25 to 1.50% of at least one catalyst, and a pigment, further adding approximately 4.0 to 15.0% of a polyester particulate and approximately 30.0 to 60.0% of the ground calcined flint clay to form a mixture, mixing the mixture under high speed and vacuum to form a blended mixture, dispersing the blended mixture into molds, heating the blended mixture filled molds to form castings, and cooling the castings under controlled conditions.

The present invention provides for a naturally appearing solid surface product that retains and incorporates the technological advantages of modem solid surface materials, while at the same time, presenting the natural beauty and randomality of stone for use as a solid surface product. Those and other advantages and benefits of the present invention will be apparent from the Detailed Description of the Preferred Embodiment.

### DETAILED DESCRIPTION OF THE PREFERRED EMBODIMENT

The present invention involves the use of fired clay, in particular flint clay, as a filler particulate and substitute for standard polymeric particulate commonly used in solid surface products. As well, the present invention is also a substitute for ground stone as used in engineered stone products.

Clay products are known and commonly used in their refined, yet raw state, in polyester resins as organic thixing agents to increase the visocity of resin solutions. The term “thixing” is a chemical term that is used to define the increase in viscosity of liquids due to the addition of thixing agents such as fumed silica. Thixing is usually accomplished under high shear mixing which allows the silica platelets to arrange themselves in a polar orientation which maintains their suspension and that of other fillers which may be included. However, these clay products are finely ground powders with visible identification limited to the tint, or coloration effect given to such solutions once they are dissolved, much the same as powdered pigments. Also, these organic clay thixing agents are limited to a monochromatic appearance.

Many types of sedimentary clays exist and may be useful for inclusion in polyester castings. However, clays vary widely in type, color and composition. Further, virtually all clays, in their natural state, would be unsuitable for use as a particulate filler. Also, most clays, when fired or calcined, to make them suitably hard enough for surfacing use, will only produce a monochromatic color. The monochromatic color may range from off-white to gray, tan to reddish brown, yellow to ochre. The fired clays are generally limited to one color, and its varying shades, depending on clay type.

Flint clay was chosen for these experiments because it was discovered early on that the hardness of flint clay could be controlled by varying the time and temperature of calcination. Table 1., infra.

Secondly, flint clay is unique in that deposits (found in Missouri), contain trace amounts of various metals. These metals, iron, lithium, copper, cobalt, aluminum, tin and lead are present singly, or in combination, in amounts varying from 0.00002-02.00 weight percent. When the flint clay which contains the various trace metals is calcined, the trace metals, through oxidation, produce various shades of color including, tans, pinks, rose, black, grays, greens, yellows and browns in the fired clay. These color combinations are useful, in that they produce a very natural pallet of colors that replicates stone when combined in solid surface products.

Additionally, the calcined flint clay, when fired, possess adequate physical integrity to withstand rigorous crushing without disintegration. This allows the manufacturer to control the particle size distribution, see Table 2., infra., and therefore the particle packing in a solid surface mixture which controls settling of fillers during the production process of solid surface.

Finally, calcination causes a structural collapse of the clay ore which results in a densified material that is resistant to staining and fracture. Also, during the firing process, escaping water of hydration produces surface micro and macro porosity which enhances the cementitious bond strength between the resinous matrix and the clay filler producing a solid surface material that is superior in strength to an all polymer product.

### EXAMPLES

Flint clay is mined by and available from the Christy Minerals Company in High Hill, Mo. The present invention involves a method of processing raw flint clay for it to be useful in producing a solid surface product. The process involves hardening the flint clay by firing it in a rotary kiln. This allows the ore contained in the flint clay to be heated uniformly. Heating temperature and time are critical to producing a clay that is of adequate strength, but not considerably harder than standard solid surface compositions. The importance of this feature has to do with the workability of the final material. Historically, solid surface materials have retained properties that allows the product to be cut, shaped and finished using standard wood working equipment rather than the specialized equipment needed for stone work.

Additionally, overly fired flint clay will become very dense, and the resulting product will weigh more per square foot than is acceptable for solid surface products. Over fired flint clay is produced by using too high of a temperature, or too long of a firing time period. Over fired flint clay will transition the clay into mullite. This is a conversion product of many aluminum silicate ores with a hardness approaching that of quartz.

Ideally, the raw flint clay ore is placed in a rotary kiln (calciner), for 1.5 to 2 hrs. at a temperature of approximately 1400° F. The suitability of the fired clay can be measured by two methods. The first method is based on specific gravity. The raw clay should preferably transition from a specific gravity of 2.381-2.418 before firing to a specific gravity of 2.084-2.115 after firing. The second method of measuring the suitability of the fired clay is measurement of Loss On Ignition, (LOI). LOI is the loss of residual combustible material retained in the clay after calcination. The LOI test may be performed by weighing a sample of the calcined ore, then firing the ore at 900C for 1.5 hours, allowing the sample to cool and then re-weighing the sample to determine the percent of weight loss. Correctly fired clay preferably has an LOI of 1.5 to 4 percent.

Table 1. illustrates the effect of firing temperature and time on flint clay.

TABLE 1

| Temperature, ° F. | Time, mins. | Barcol Hardness of cast clay* |
|---|---|---|
| 900 | 90 | 20 |
| 900 | 120 | 35-40 |
| 1400 | 90 | 55-60 |
| 1400 | 120 | 60-85 |
| 1900 | 90 | >100 |
| 1900 | 120 | >100 |

*Typical barcol hardness values for solid surface materials are 45-80.

Flint clay, once calcined, may need to be ground to a desirable particle size distribution before it is suitable for use. For best results, the grinding process is accomplished with either the use of a ball mill, or a hammer mill. Table 2. shows typical particle size distribution.

TABLE 2
Screen Analysis

| | Individual | Cumulative |
|---|---|---|
| Material: NO 2, Size: 1/2 × 4 | % Retained | % Retained |
| Retained Upon: US 1/2 | 0 | 0 |
| Retained Upon: US 3/8 | 4.2 | 4.2 |
| Retained Upon: US 265 | 32.4 | 36.6 |
| Retained Upon: US 4 | 32.9 | 69.5 |
| Retained Upon: US 6 | 19.9 | 89.4 |
| Retained Upon: US 8 | 4.9 | 94.3 |
| Retained Upon: US 10 | 2.5 | 96.8 |
| Retained Upon: PAN | 3.2 | 100 |

(From the screen analysis, an even and proportional mixture of all particle sizes are selected as the particulate/filler flint clay in the following example).

### Examples

Table 3. shows the blend composition of one embodiment of the present invention.

TABLE 3

| Item # | Ingredient | Percent by Weight |
|---|---|---|
| 1. | Polyester Resin solution, 40% monomer | 34.37 |
| 2. | MEKP-9 (catalyst) | 00.26 |
| 3. | BPO LV40 (catalyst) | 00.27 |
| 4. | Aerosil 200 | 00.94 |
| 5. | BYK A-555 | 00.34 |
| 6. | BYK W-940 | 00.63 |
| 7. | Alumina Trianhydrate | 11.97 |
| 8. | Pigment | 00.10 |
| 9. | Fine clear polyester particulate | 04.97 |
| 10. | Flint Clay, Geodite | 46.15 |

The ten ingredients as listed in Table 3 are combined in a suitable mixer in the order they are listed. The mixer, for best results, may be a double planetary mixing apparatus that achieves high speed and thorough mixing.

The polyester resin solution (Item 1), is a blend of isophthalic polyester resin solution and orthophthalic polyester resin solution. This polyester resin solution is commercially available from Ashland Chemical Corp., Reichold Chemical Corp., British Petroleum Chemical, and others. The polyester resin solution acts as a binder, or the reactive cementitious portion of the material which holds the fillers, Items 7, 9 and 10, together. MEKP-9 and BPO LV40 (Items 2 and 3), whose chemical names are methyl ethyl ketone peroxide and benzoyl peroxide respectively, are commercially available from U.S. Peroxygen, Reichold Chemical Corp, Norac and Witco. MEKP-9 and BPO LV40 are the catalysts which convert the polyester solution into a solid. Aerosil 200 (Item 4), whose chemical name is fumed silica, is commercially available from Degussa. Aerosil 200, the fumed silica, is a thixing agent and helps to stabilize the fillers so that they do not stratify. BYK 555 (Item 5), is commercially available from BYK Chemie. BYK 555 is an air release agent and helps to prevent air voids in the final casting. BYK 940 (Item 6), is also commercially available from BYK Chemie. BYK 940 is a wetting agent, which assists in the addition of fillers and in maintaining the proper viscosity. BYK Chemie does not divulge the chemical names or composition of BYK 555 and BYK 940, however, they are combinations of polymers, polysiloxanes and aromatic hydrocarbons.

Further, Alumina Trianhydrate, ATH, OC1000, (Item 7), which is a precipitated form of alumina trihydrate (“ATH”), is commercially available from Alcoa under the tradename OC 1000. The ATH particle size of OC 1000 is in the 15-25 micron range. ATH is used in the present embodiment to distribute heat during the exothermic reaction to increase mechanical properties, and also to create a fire suppressant chemical reaction should the material ever be exposed to excessive heat. Pigment, (Item 8), is simply a colorant, and is interchangeable for the desired color of the product. Pigments of this nature are commercially available from Neste Corp., American Colors, Ram Chemical, and many others. Fine clear particulate, (Item 9), whose chemical name is polyester resin solids that have been finely ground, is manufactured by Avonite Inc. Fine clear particulate is used to give the product a degree of translucency, to enhance the workability of the product and reduce the density, or weight per square foot.

Lastly, Geodite (Item 10), is flint clay available from Christy Minerals Company which has been calcined, ground and manufactured to Avonite specifications, as previously discussed. Geodite is used to give mechanical properties and the appearance of terrazzo, or stone.

The process consists, more specifically, of filling a vessel with the desired amount of unsaturated polyester resin, and then adding to the resin the catalyst, wetting agent, air release agent, and pigment. The dry additives are then added. That is, the ground polyester particles, alumina trihydrate, ground flint clay and fumed silica are added according to the formula amount. The mixture is mixed, under high speed and vacuum of 25 inches for approximately 30-60 minutes. After mixing, the mixture is dispersed into molds. Aluminum molds may be used, although not required. The molds are then placed into an autoclave at approximately 200° F. and 110 psi for approximately 45-60 minutes. The molds are then removed from the autoclave and the castings are allowed to cool under controlled conditions for one to four hours.

Of the many product applications of which the present invention may be used, that of countertops, flooring, wall cladding, table tops, lawn furniture and stepping stones are just a few.

While the present invention has been described in conjunction with a preferred embodiment, those of ordinary skill in the art will recognize that many modification and variations are possible. The following claims are intended to cover all such modifications and variations.

What is claimed is:

1. A composition of matter prepared by a process comprising the steps of:
(A) heating, in a rotary kiln, flint clay having a specific gravity of 2.381-2.418 to a temperature of from approximately 900° F. to 1900° F. for approximately 90 minutes to 120 minutes; and
(B) thereafter recovering calcined flint clay having a specific gravity of 2.084-2.115 and a LOI of 1.5%to 4%.

2. A composition comprising:
a polyester resin solution; and
a calcined flint clay particle having an LOI of 1.5% to 4% in the 325 micron to one half inch size range.

3. The composition according to claim 2 wherein said polyester resin solution is a blend of isophthalic polyester resin solution and orthophthalic polyester resin solution.

4. The composition according to claim 3 wherein said polyester resin solution is 40% monomer.

5. The composition according to claim 2 wherein said polyester resin solution is a blend of 75% isophthalic neo-pentyl glycol and 20% orthophthalic polyester with 5% of a flexibilizing polyester.

6. The composition according to claim 5 wherein said flexibilizing polyester is adipate.

7. A calcined flint clay particle having a specific gravity of 2.084-2.115 and a LOI of 1.5%-4%.

8. The calcined flint clay particle of claim 7 having a size of 325 micron to ½ inch.

9. The calcined flint clay particle of claim 8 having a Barcol Hardness value of from 20 to greater than 100.

10. A process of making a flint clay product useful as a filler comprising the steps of:
(A) heating, in a rotary kiln, flint clay having a specific gravity of 2.381-2.418 to a temperature of from approximately 900° F. to 1900° F. for approximately 90 minutes to 120 minutes; and
(B) thereafter recovering calcined flint clay having a specific gravity of 2.084-2.115 and a LOI of 1.5%to 4%.

11. The process according to claim 10 additionally comprising the step of grinding the flint clay to a particle size in the 325 micron to ½ inch size range.

12. The process according to claim 11 wherein the heating step comprising heating the flint clay to achieve a Barcol Hardness value of from 20 to greater than 100.

13. A composition comprising:
a polyester resin solution;
a calcined flint clay particle having an LOI of 1.5% to 4% in the 325 micron to one half inch size range;
a colorant; and
a clear polyester particulate.

14. The composition according to claim 13 additionally comprising:
an air releasing agent;
a wetting agent;
a thixing agent; and
an alumina trianhydride particle in the 15-25 micron size range.

15. The composition according to claim 14 wherein said air releasing agent and said wetting agent are combinations of polymers, polysiloxanes and aromatic hydrocarbons.

16. The composition according to claim 15 wherein said thixing agent is fumed silica.

17. A solid surface material comprising:
from 35-75 weight percent of polyester resin;
up to 0.25 weight percent of a colorant;
up to 20.0 weight percent of a clear polyester particulate; and
from 25-65 weight percent of calcined flint clay in the 325 micron to one half inch range.

18. The solid surface material according to claim 17 additionally comprising:
up to 00.5 weight percent of an air releasing agent;
up to 00.1 weight percent of a wetting agent;
up to 01.0 weight percent of a thixing agent; and
up to 30.00 weight percent of an alumina trianhydride particle in the 15-25 micron size range.

19. The solid surface material according to claim 18 wherein said air releasing agent and said wetting agent are combinations of polymers, polysiloxanes and aromatic hydrocarbons.

20. The solid surface material according to claim 19 wherein said thixing agent is fumed silica.

21. The solid surface material according to claim 20 wherein said polyester resin is a blend of isophthalic polyester resin solution and orthophthalic polyester resin solution.

22. The solid surface material according to claim 21 wherein said polyesterresin is 40% monomer.

23. The composition according to claim 20 wherein said polyester resin solution is a blend of 75% isophthalic neo-pentyl glycol and 20% orthophthalic polyester with 5% of a flexibilizing polyester.

24. The composition according to claim 23 wherein said flexibilizing polyester is adipate.

25. A method of making a solid surface product, comprising:
heating flint clay having a specific gravity of 2.381-2.418 to a temperature of from approximately 900° F. to 1900° F. for approximately 90 minutes to 120 minutes to form calcined flint clay having a specific gravity of 2.084-2.115 and a LOI of 1.5% to 4%;
grinding the calcined flint clay;
filling a vessel with approximately 35.0 to 55.0% of a polyester resin solution;
adding to the polyester resin solution approximately 0.25 to 1.50% of at least one catalyst, and a pigment;
further adding approximately 4.0 to 15.0% of a polyester particulate and approximately 30.0 to 60.0% of the ground calcined flint clay to form a mixture;
mixing the mixture under high speed and vacuum to form a blended mixture;
dispersing the blended mixture into molds;
heating the blended mixture filled molds to form castings; and
cooling the castings under controlled conditions.

25. The method of making a solid surface product according to claim 24 wherein the step of adding to the polyester resin solution at least one catalyst and a pigment additionally includes adding approximately 0.2 to 1.0 of a wetting agent, and approximately 0.2 to 1.0 of an air release agent.

26. The method of making a solid surface product according to claim 25 wherein the step of further adding polyester particulate and ground flint clay additionally includes adding approximately 10.0 to 20.0 of alumina trianhydrate and approximately 0.50 to 1.0 of fumed silica.

27. A method of making a solid surface product, comprising:
filling a vessel with approximately 35 to 55% of a polyester resin solution;
adding to the polyester resin solution approximately 0.25 to 1.50 of at least one catalyst, and a pigment;
further adding approximately 4.0 to 15.0% of a polyester particulate and approximately 30.0 to 60.0% of ground calcinated flint clay having an LOI of from 1.5% to 4% to form a mixture;
mixing the mixture under high speed and vacuum to form a blended mixture;
dispersing the blended mixture into molds;
heating the blended mixture filled molds to form castings; and
cooling the castings under controlled conditions.

28. The method of making a solid surface product according to claim 27 wherein the step of adding to the polyester resin solution at least one catalyst and a pigment additionally includes adding approximately 0.20 to 1.0% of a wetting agent, and approximately 0.20 to 1.0% of an air release agent.

29. The method of making a solid surface product according to claim 28 wherein the step of further adding polyester particulate and ground calcined flint clay additionally includes adding approximately 10.0 to 20.0% of alumina trianhydrate and approximately 0.50 to 1.0% of fumed silica.

30. A composition of matter prepared by a process comprising the steps of:
heating flint clay having a specific gravity of 2.381-2.418 to a temperature of from approximately 900° F. to 1900° F. for approximately 90 minutes to 120 minutes to form calcined flint clay having a specific gravity of 2.084-2.115 and a LOI of 1.5% to 4%;
grinding the calcined flint clay;
filling a vessel with approximately 30.0 to 60.0% of a polyester resin solution;
adding to the polyester resin solution approximately 0.25 to 1.50% of at least one catalyst, and a pigment;
further adding approximately 4.0 to 15.0% of a polyester particulate and approximately 30.0 to 60.0% of the ground calcined flint clay to form a mixture;
mixing the mixture under high speed and vacuum to form a blended mixture;
dispersing the blended mixture into molds;
heating the blended mixture filled molds to form castings; and
cooling the castings under controlled conditions.

31. The composition of matter prepared by the process of claim 32 wherein the step of adding to the polyester resin solution at least one catalyst and a pigment additionally includes adding approximately of a wetting agent, and approximately 0.20 to 1.0% of an air release agent.

32. The composition of matter prepared by the process of claim 33 wherein the step of further adding polyester particulate and ground calcined flint clay additionally includes adding approximately 10.0 to 20.0% of alumina trianhydrate and approximately 0.50% to 1.0% of fumed silica.
